(19) United States
(12) Patent Application Publication
(10) Pub. No.: US 2016/0051890 A1
(43) Pub. Date: Feb. 25, 2016

(54) METHOD AND APPARATUS FOR PLAYING A GAME

(71) Applicant: James Alexander Ashton, WINDSOR (GB)

(72) Inventor: James Alexander Ashton, WINDSOR (GB)

(21) Appl. No.: 14/466,961

(22) Filed: Aug. 23, 2014

(51) Int. Cl. A63F 13/213

(52) U.S. Cl. CPC A63F 13/213

(57) ABSTRACT

Method and apparatus are disclosed for playing a game involving two or more players and a referee. The game requires players to complete physical tasks, and submit recordings to task completion to the referee. Typically, the winner of the game is the player who completes a set of tasks before any other player does so. The is in the form of a portable device, possibly a mobile telephone having suitable software. The portable device includes at least a recording module, a display module and a transmitting module, and is adapted to reveal instructions for performing tasks, record an attempt at a task, and transmit the recording to the referee.

The present invention relates to a method and apparatus for playing a game, particularly for playing a game which involves the completion of tasks by players, and in which the players are required to make recordings of tasks being completed, for example video recordings or photographs.

### BACKGROUND TO THE INVENTION

It is well known for businesses to run competitions to promote their products and services, or more generally to raise awareness of their brand.

Promotional competitions often include an element of skill, and in particular many require entrants to produce for example a photograph or video including specific subject matter, for example relating to the brand being promoted. Such competitions have the advantage that they engage the entrants, who find enjoyment in completion of the task even if they do not win. The other advantage of a photo or video competition is that entrants generate a large number of photographs or videos which can be used by the promoter for marketing purposes, often on social media websites.

The disadvantage of this kind of competition is that it takes time to determine a winner. If photographs are submitted to a photography competition then inevitably there will have to be some judging process to determine a winner, which takes time. The more popular the competition, the more time the judging process will take. This makes it difficult to run an engaging competition, because many entrants may have forgotten about it by the time results are announced. The time delay before a winner is announced also makes it difficult to engender a “competitive spirit” to motivate players, since they cannot see the immediate results of their efforts.

Other promotional competitions are games of chance, the simplest being a prize draw. A winner is chosen at random from all of the entrants. This type of competition is cheap and easy to run, and with modern communications technology can be promoted, concluded and a winner announced within a very short period of time. However, because entrants are not required to actually do anything, the competition is unengaging and unmemorable for the vast majority of players who do not win.

Hybrid competitions are also known, which include elements of luck and creative skill In a simple example a random subset of entries to a photography competition could be selected for judging and thus the possibility of winning. This reduces the time taken by the judging process whilst maintaining an element of skill and resulting in the creation of media which can be used by the promoter. However, such hybrid competitions amount to no more than a measured compromise between the disadvantages of the above described “luck” and “skill” competitions.

In some games of skill, a player's performance can be measured automatically very easily and therefore the game can be run in a short period of time. Many simple computer games fall into this category, but they tend to be repetitive and do not provide great variety. This type of game often measures good motor skills and fast reactions, within a certain context. Some players will enjoy the game and may even find it highly addictive, but others will quickly become bored. Players who do not perform well immediately will tend to continue to lag behind the top players, and will lose motivation when they realise that they are likely never to win. From a promoter's point-of-view, this is a serious disadvantage since it alienates a large number of people at an early stage.

It is an object of the present invention to provide apparatus and methods for playing a highly engaging game of skill, which can be promoted, played and concluded within a very short period of time, and which involves the creation of original creative works by the players.

It is a further object of the invention to provide apparatus and methods for playing a game in which there is a clear winner by an objective measure, depending only on a comparison of the players' submissions but without requiring a time-consuming judging process. The apparatus and methods are flexible enough to allow for use with games having different rules, which allow games to be provided which will appeal to and engage players having different skills, and different amounts of experience.

### STATEMENT OF INVENTION

According to a first aspect of the invention, there is provided apparatus for playing a game involving two or more players and a referee,
the apparatus being suitable for use in games having rules for game play that include instructions for performing tasks, rules as to when the instructions for performing the tasks are revealed to players, as to the order and timing which players must apply to performance of the tasks, and as to the allocation and selection of tasks to and by players, and the rules further including win criteria for determining one or more winner(s) of the game dependent on the performance of tasks by the players,
the apparatus comprising a portable device for use by each player, the portable device including a recording module, a display module and a transmitting module, the portable device being adapted to perform the steps of:
   a) revealing instructions for performing at least one task on the display module, according to the rules;
   b) activating the recording module to allow the player to make a recording of an attempt to perform at least one of the revealed task(s);
   c) returning to step (b) for a next task according to the rules, until the referee indicates that the game has ended,
and in which the portable device is further adapted to transmit each recording to the referee.

The tasks defined by the rules of the game are typically physical tasks which the player must perform, for example, performing five “kick-ups”, balancing three books on his head, or standing on one leg on top of a van while holding an orange. The tasks can be chosen to involve greater or lesser amounts of skill In the above examples, most able-bodied persons would have no difficulty in standing on one leg, but many players who do not practice football would struggle with the “kick-ups” task. However, even the tasks which do not require skill as such can be enjoyable if they are unusual and quirky. Some tasks will necessarily involve the player performing an odd activity in a public place, and the “skill” in this case may amount to no more than the player being confident enough to overcome the embarrassment factor which would cause other players to hesitate.

Some tasks may be purely circumstantial, for example involving no more than obtaining a photograph of a particular thing or situation. However, it is envisaged that for maximum engagement, most tasks should involve some kind of action by the player, or at the very least involve the player being visible or audible in the recording.

It is possible that some tasks may be such that it is possible to complete them to a greater or lesser quality. For example, there could be a task for the player to perform as many kick-ups as he can, and a score could be allocated depending on the number. However, it is envisaged that in most games the tasks will simply be of a pass/fail nature, which allows for simplicity of scoring and obviates the need for a lengthy judging process.

The number of different types of task which can be included in the rules of a game to be played using the apparatus of the invention is virtually limitless. There is an enormous amount of flexibility, and in the context of running promotional competitions this allows a promoter to select tasks relevant to his brand and suitable for his target market. Moreover, each game may be played only once before being replaced by a new game with new tasks. The games continue to be attractive to new players because the constantly changing tasks do not lend themselves to particular players becoming very good and dominating subsequent games.

Rules for a simple game might specify that the winner is the player who completes all of the tasks in the game in the least amount of time. There may of course be second and third prizes and so on. More complex game rules might give players a choice, for example specifying that the first player to complete any three out of five tasks is the winner.

The order in which players must complete tasks can also be defined by the rules, and the rules also define when the instructions for each task are revealed to players. In one example set of rules, the instructions for all tasks are revealed to the user at the start of the game, in another example set of rules, the instructions for the next task are only revealed once the current task has been completed. It will be appreciated that there are a large number of possible rules in this respect—for example involving revealing instructions based on time rather than task completion, or revealing partial instructions at an early stage and more detailed instructions later.

The recording module may include a camera, and each recording may be a photograph or video recording. As an alternative, it is envisaged that some recordings may be a sound recording, but photographs and videos are considered preferable. The type of recording (photograph, video, or sound recording) may be defined for each task by the rules of the game.

The portable device may be further adapted to perform the step of:
(b(i)) revealing instructions for performing at least one next task, according to the rules,

step b(i) taking place after step (b) and before step (c).

This type of device is suitable for use in games where the rules specify that instructions for the next task are only revealed after completion of the current task.

Instructions for performing more than one of the tasks as defined in the rules to be allocated to the player who is using the portable device may be revealed at step (a). A device which is adapted in this respect is suitable for use in games where the rules specify that instructions for multiple tasks are to be revealed at the outset, irrespective of whether or not the rules give the player a choice as to the order in which the tasks may be completed.

Step (b) may allow the player to choose which of the revealed tasks they are to attempt and record. Alternatively, the device may specify the task to be completed, where the rules of the game prescribe the order of tasks and do not allow the player a choice in this respect.

Each recording may be transmitted to the referee after step (b) and before step (c). Transmitting recordings to the referee as and when the tasks are completed ensures that the referee can maintain and distribute an accurate and up-to-date scoreboard, taking into account tasks as soon as they are completed. However, because the transmitting module of the portable device may sometimes be out of range of a base station, or otherwise unable to successfully transmit the recording, it may be advantageous in some embodiments to transmit the recordings to the referee asynchronously of the steps. In this case, each recording may be transmitted to the referee along with timing information to indicate the time at which the recording was made.

In particular, the portable device may be a mobile telephone with mobile data capability, and provided with appropriate software. Such a device must be within range of a cellular base station in order to transmit recordings.

The portable device may be further adapted to perform the step of:
(b(ii)) accepting input from the player to accept or reject the recording made, and if the user accepts the recording then proceeding to step (c), and if the user rejects the recording then returning to step (b) to make a new recording of an attempt at the same task,

step b(ii) taking place after step (b) and before step (c).

Step b(ii) essentially asks the user whether they are happy that they have successfully recorded completion of the task. If they are not then they may make another attempt. The rules of the particular game will dictate whether the player is allowed repeat attempts, and if so how many attempts are allowed. A device adapted to perform step b(ii) is suitable for use in a game where the rules allow at least one repeat attempt.

It is also envisaged that rules of particular games may dictate at what point a player may make another attempt. For example, in games where instructions for the next task are only revealed on completion of the current task, the rules are very likely to prohibit repeat attempts at previous tasks after the instructions for subsequent tasks have been revealed.

The number of repeat attempts allowed may be defined by the rules for individual tasks within a game, so for example some tasks in a game may allow multiple or even unlimited attempts, and other tasks may need to be completed in a only a few attempts, or at the extreme in a single attempt.

The apparatus may further comprising a referee device, the referee device including:
a receiving module for receiving recordings transmitted by players' portable devices;
a validation module for determining whether or not selected recordings evidence the correct completion of a task according to the rules;
a scoring module for tracking which recordings have been validated, tracking the performance of each player and determining when the win criteria according to the rules has been met;
a transmitting module for transmitting game information to players.

The game information transmitted to players may include a notification to players when the game has been won. It may alternatively or additionally include scoring information transmitted throughout the game, and/or results of validations relating to the players' transmitted recordings.

The role of the referee is to co-ordinate the game, validate recordings to determine whether the tasks have in fact been correctly completed, keep score and eventually announce a winner.

It is envisaged that in some embodiments the role of the referee may be entirely automated. This has obvious advantages in terms of efficiency in running the game, and may be possible where the tasks lend themselves to automatic validation. For example, a task could involve taking a photograph of a billboard displaying the promoter's advertisement, and image recognition software would be able to validate this. However, to allow the fullest variety of tasks to be incorporated into games played using the device, it is envisaged that in more embodiments there will be a person who performs some of the referee functions, in particular the validation function. Nevertheless, the referee device assists the human referee in performing his job efficiently.

In particular, the validation module of the referee device may include a playback module for playing or displaying selected recordings and an input module,
the referee device being adapted to perform the steps of:
(a) selecting a recording for validation according to rules;
(b) playing or displaying the selected recording on the playback module;
(c) accepting input as to whether or not the selected recording indicates correct completion of a task according to the rules;
(d) updating stored data in the scoring module to include the information input at step (c).

The step of selecting recordings is critical in allowing the referee to run the game fairly but efficiently. Clearly, if every recording had to be validated then that would amount to an onerous and costly judging process, and delay announcement of the results. However, by selecting recordings for validation according to rules, the referee device ensures that there is a clear, unambiguous and deserving winner of the game without validating every recording.

In a simple embodiment, the rules might specify that the first player to complete five tasks is the winner. Once a player has become the first player to upload five recordings purporting to indicate completion of the tasks, the referee device selects those five recordings for validation. Once validation is complete, the referee device either announces the winner (if all five recordings are valid) or adjusts the purported winner's score (for example, to 3 out of 5 if only three of the recordings were valid) and allows the game to continue until another purported winner arises.

More complex referee devices might include automatic aspects which filter out recordings that are clearly invalid (for example, completely blank photographs, photographs downloaded from the internet etc.). Other more complex devices may attempt to predict likely winners before the win criteria has been met. For example, if the win criteria is to complete five tasks then the referee device may select for validation all recordings submitted by players who purport to have completed four tasks, and the referee device may also prioritise the recordings for validation based on how quickly each player uploaded the first four tasks. Where the rules of the game allow the player to choose the order in which tasks are completed, the referee device may take into account pre-stored estimates of the time each task is likely to take to complete, in order to predict a likely winner. The aim is to ensure that once a player reaches the win criteria, the time delay before all of his recordings have been validated and his win confirmed and announced is minimised. If the referee device is able to predict likely winners and select their recordings for validation, then hopefully a player uploading his fifth recording (in an example game where five completed tasks in the least time are required to win) will have already had his four previous recordings validated by the referee. His win will be confirmed and announced as soon as the fifth recording is validated.

According to a second aspect of the invention, there is provided a method of playing a game involving two or more players and a referee,
the method being suitable for use in games having rules for game play that include instructions for performing tasks, rules as to when the instructions for performing the tasks are revealed to players, as to the order and timing which players must apply to performance of the tasks, and as to the allocation and selection of tasks to and by players, and the rules further including win criteria for determining one or more winner(s) of the game dependent on the performance of tasks by the players,
the method comprising the steps of:
   (a) providing each player with a portable device which includes a recording module, a transmitting module and a display module, the portable device being adapted to reveal instructions for performing tasks according to the rules, allow recordings to be made of attempts to complete said tasks, and transmit the recordings to the referee;
   (b) each player completing a plurality of tasks according to the rules, the step of completing a task comprising:
      i. viewing revealed instructions for performing a task on the display module of his portable device;
      ii. attempting to perform the task and recording the attempt on the recording module of his portable device.

Each player may execute the step of completing a task asynchronously and independently of the other players. In most games in which it is envisaged that the method may be applied, the rules may specify win criteria which includes completing a number of tasks in the least possible time. In other words, most games will be a race to complete the tasks—players do not “take turns”. However, players may be aware of the progress of other players as the referee may transmit up-to-date scoreboard information to the portable devices held by the players, and each portable devices may be adapted to display this scoreboard information on the display module.

The method may further comprise the steps of
the referee receiving recordings of attempts to complete tasks from the portable devices provided to players;
the referee validating a plurality of recordings, the step of validating a recording comprising:
   (a) playing back the recording and determining whether or not the task has been successfully completed according to the rules;
   (b) marking the recording as to whether or not it evidences successful completion of the task.

The referee may use a referee device as described above, to increase the efficiency with which he is able to select recordings for validation, validate each recording, and mark each recording as to the validation result. Marking the recording is understood to mean making any record of the validation result, linked to the recording. It is envisaged that in most cases the referee will use a referee device which includes a computer database for this purpose. Keeping score and announcing the winner(s) may thus be automated.

Again, in some embodiments a level of automation may be possible in terms of the actual validation stage, and in principle the role of the referee may be played by a machine. However, for the widest variety of tasks a human referee is desirable.

The referee performs the step of validating a recording asynchronously of receiving recordings from players. In particular the referee may validate recordings selected for the greatest efficiency in terms of confirming and announcing the correct winner in the least possible amount of time. The referee may use a referee device as described above to assist with this.

The recording may be a photograph or video. Alternatively, in some embodiments sound recordings or other types of recording may be included.

According to a third aspect of the invention, there is provided a method of playing a game involving two or more teams and a referee, each team including two or more players,
the method being suitable for use in games having rules for game play that include instructions for performing tasks, rules as to when the instructions for performing the tasks are revealed to players, as to the order and timing which players must apply to performance of the tasks, and as to the allocation and selection of tasks to and by players, and the rules further including win criteria for determining one or more winning team(s) dependent on the performance of tasks by the players,
the method comprising the steps of:
   (a) providing each player with a portable device which includes a recording module, a transmitting module and a display module, the portable device being adapted to reveal instructions for performing tasks according to the rules, allow recordings to be made of attempts to complete said tasks, and transmit the recordings to the referee;
   (b) each team completing a plurality of tasks according to the rules, the step of completing a task comprising:
      i. at least one player in the team viewing revealed instructions for performing a task on the display module of his portable device;
      ii. at least one player in the team attempting to perform the task; and
      iii. at least one player in the team recording the attempt on the recording module of his portable device.

The ‘team’ version of the method may in fact have embodiments in common with the second aspect of the invention. For example, the win criteria in the rules of the game could group players into teams, and specify that the winners are all of the players in the winning team, the winning team being the team in which all members complete all tasks before all of the members of another team do so. In this example, the game play experience for an individual player is fundamentally unaffected by the ‘team’ aspect—the individual player still has to act as an individual and complete the tasks as quickly as possible. However, this method is also suitable for application in games with more complex rules, to enhance the team play aspect. For example, it may be that rules specify that a team of three players has to complete fifteen tasks, and that each player in the team must complete an equal number of tasks (so five each), but that the players in a team can choose how to allocate the tasks amongst each other. Therefore, the team members can collaborate and allocate the tasks amongst themselves according to their perceived strengths.

A single step of completing a task may be performed in its entirety by a single player in the team.

In this example each player in the team still completes his allocated tasks as an individual, and so in principle the members of a team could be remote from each other. However, the allocation of the tasks is thought to build a ‘team spirit’ and enhance enjoyment of and engagement with the game.

Alternatively, the step of completing a task may involve two or more players in the team attempting to perform the task, while at least one player in the team makes a single recording of the attempt. The player making the recording may or may not be the same as one of the two or more players attempting to perform the task.

Game rules which include more complex team aspects are practical where the members of a team are physically co-located. For example, certain tasks could require the involvement of more than one team member. An example task might be for example for all team members to appear in the same photograph without any of their feet touching the ground, and with each player in the team touching another player's nose.

“A player making a recording” might be taken to include the player making arrangements for a third-party to make the recording, for example by asking a passer-by. In some games, tasks may deliberately be designed to require the recruitment of third parties either to make the recording or to play a role in the task itself.

Where players are remote from each other, tasks may still be designed which involve all players in a team. For example, a task could include players in the same team posting embarrassing messages to each other on a social media website.

Each team may complete the same plurality of tasks in totality. But the allocation of tasks may be such that at least one player in a first team completes a different set of tasks from any player in a second team. Such allocation may be decided upon amongst the members of the team, as described above, or alternatively might be randomised and imposed on the players.

### DESCRIPTION OF THE DRAWINGS

For a better understanding of the present invention, and to show more clearly how it may be carried into effect, reference will now be made by way of example only to the accompanying drawings, in which:

FIGS. 1a and 1b show part of a portable device according to the invention, when a game is being promoted but has not yet begun;

FIGS. 2a and 2b show part of the portable device of FIG. 1, when a game is in progress;

FIG. 3 shows part of the device of FIG. 1, when a game is in progress and a scoreboard is being displayed;

FIGS. 4a, 4b and 4c show part of a referee device, in which a referee is in the process of validating recordings transmitted by players; and

FIG. 5 is a flow chart showing an overview of the operation of a player device and a referee device, including communications between the two devices.

### DESCRIPTION OF PREFERRED EMBODIMENT

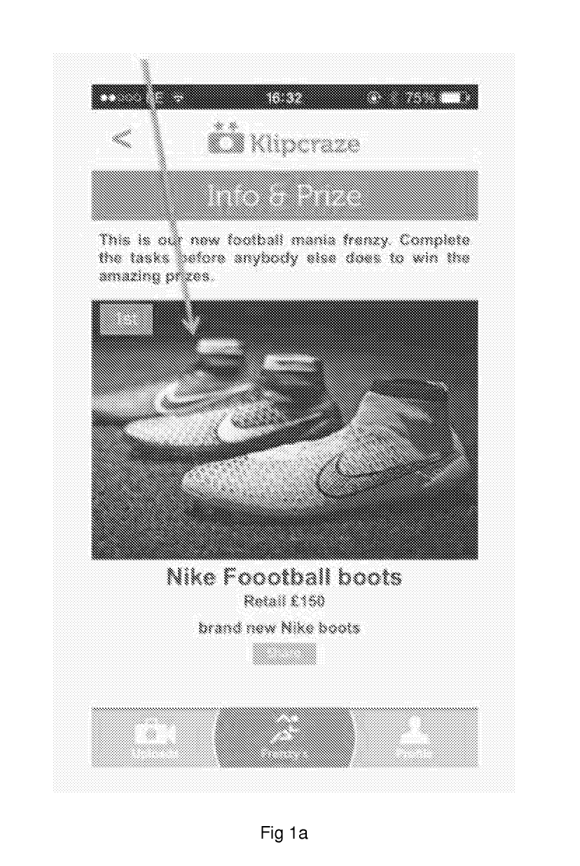

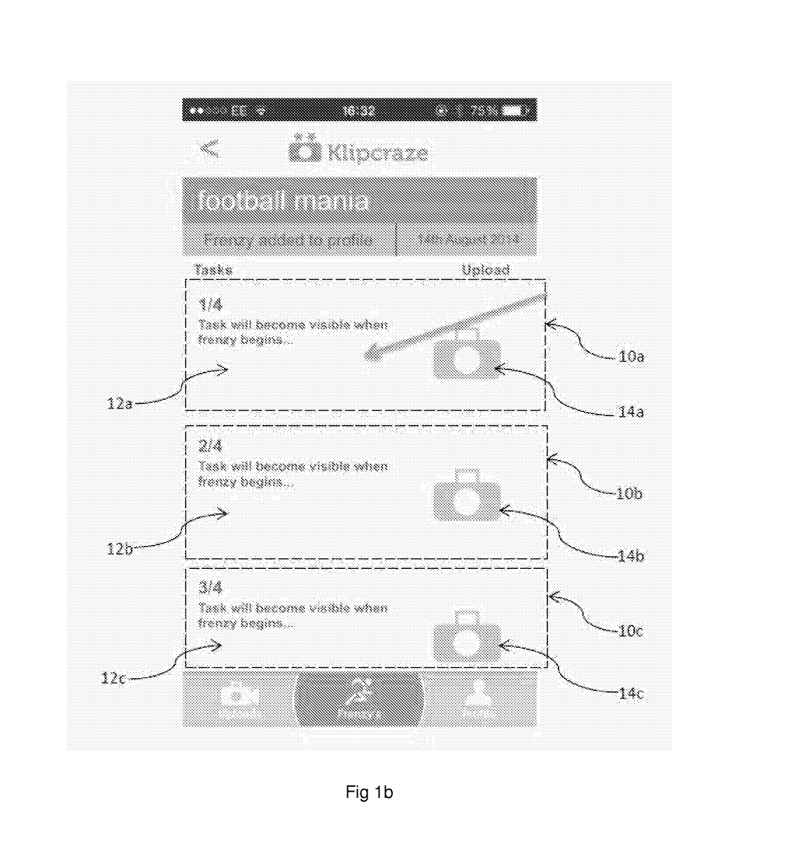

In one example embodiment, apparatus for playing a game comprises a portable device in the form of a modern smartphone, which includes a recording module in the form of a camera, touchscreen display module, and a transmitting module in the form of a cellular modem, and which is provided with suitable software. FIGS. 1a, 1b, 2a, 2b, and 3 all show screenshots of the touchscreen display module on such a device.

In FIGS. 1a and 1b, a game is being promoted. The specific game in this example is on a football theme, as may be promoted for example by a sportswear company, broadcaster, or anyone else whose business is closely linked to football. In FIG. 1a, the display screen of the portable device gives a brief description of the rules, which in this case are simple—the first person to complete all tasks will win the game, and a pair of football boots.

The advertised prize is a desirable consumer item of reasonably high value. Players will be motivated to complete the tasks to win the prize.

In FIG. 1b, the display screen shows a list of tasks. However, in this game, the rules specify that the instructions for performing each task are not revealed to the players until the game commences. All the player can see at this stage is that there are four tasks. The portable device in FIG. 1b is in a task list display mode, which is the primary mode which will be used throughout a game. In task list display mode, a plurality of task regions 10a, 10b, 10c are provided on the touch screen display. Each task region includes a task instruction region 12a, 12b, 12c and a recording activation region 14a, 14b, 14c. Each task region relates to a single task which a player is to perform as part of a game. The task instruction region for each task displays instructions for performing the task, according to the rules of the game. In some games, the rules will specify that instructions are revealed only at particular points, and in FIG. 1b it may be seen that no tasks are visible in this case before the start of the game.

When a player wants to record an attempt to complete a task according to the rules, he or she can touch the recording activation region 14a, 14b, 14c of the touch screen display. This activates the recording module of the portable device, which in this embodiment is a camera.

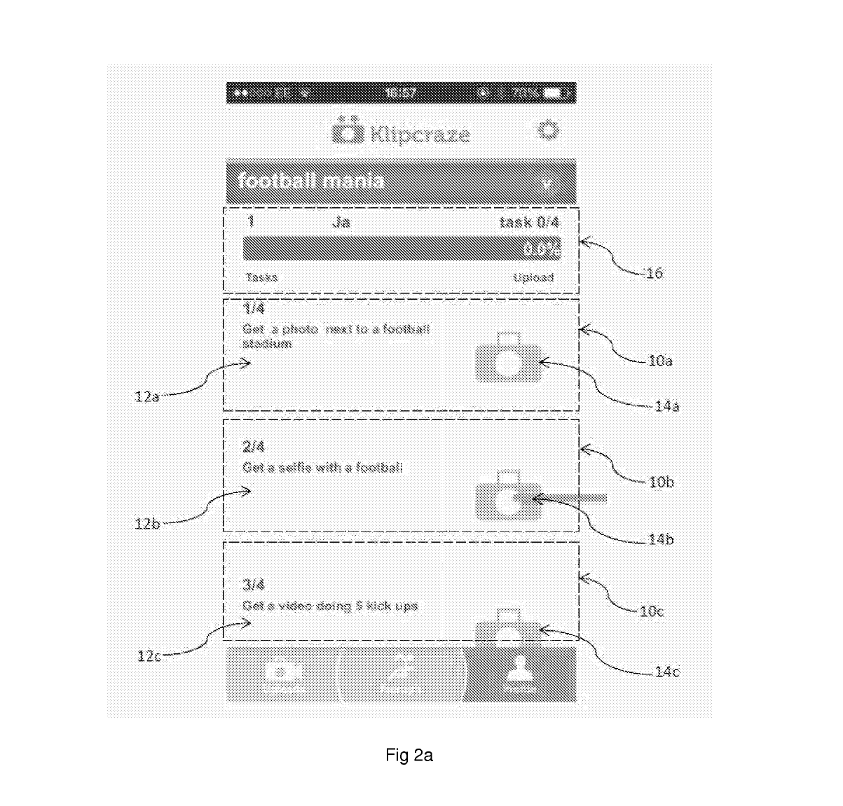

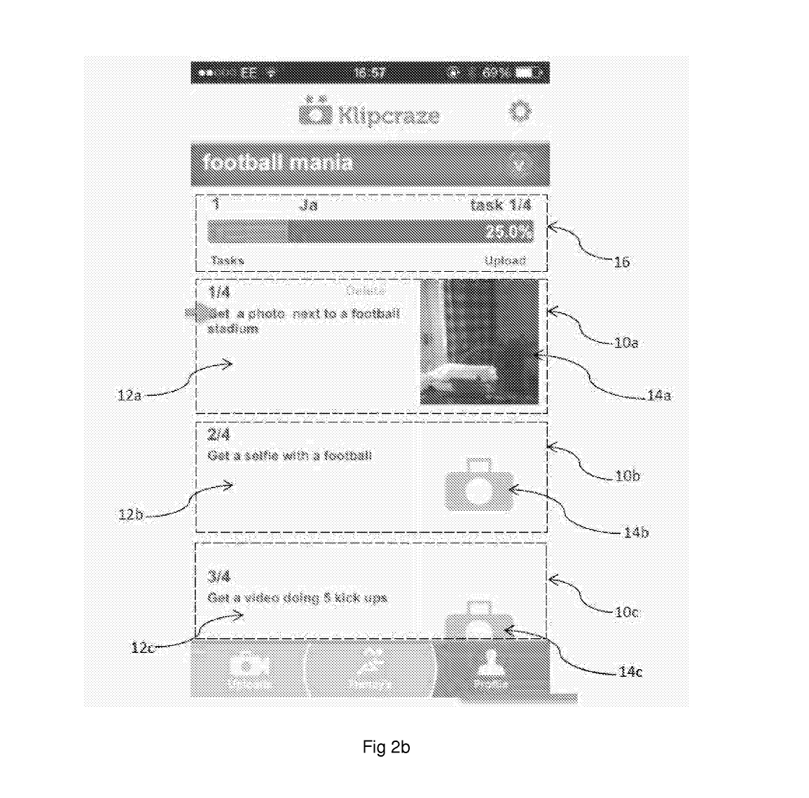

FIG. 2a shows the display screen of the portable device immediately after the game has begun. In this example game, the rules specify that all of the instructions for all of the tasks are revealed to each player at the beginning of the game. Furthermore, the rules in this game allow each player to choose the order in which tasks are completed.

In FIG. 2a, task instructions have been displayed in the task instruction regions 12a, 12b, 12c of the touch screen display. In this game, the rules provide the player with a choice as to the order in which the tasks may be completed, and as such the user may choose which task to attempt and record by touching his choice of recording activation region out of recording activation regions 14a, 14b, and 14c. In other games, the rules may specify that the user must complete the tasks in a particular order and in that case some recording activation regions will be disabled at points during the game. Touching a disabled recording activation region will not activate a recording module but simply result in display of a message indicating that the user must complete another task first.

In task list display mode, the touch screen also displays a progress indicator 16 during game play. The progress indicator 16 provides the player with a visual representation of how close he is to meeting the win criteria for the game. In this game, the win criteria are to complete four out of four tasks before another player does so. In FIG. 2a, the player has not completed any tasks and as such the progress indicator 16 shows 0% completion.

In FIG. 2b, the user has recorded an attempt to complete task number one, by touching the recording activation region 14a. The progress indicator 16 shows 25% completion, since the user has at this stage apparently completed one of the required four tasks. It will be noted however, that the instructions for task one as displayed in the task instruction region 12a are to “Get a photo next to a football stadium”.

However, the photograph which the player has taken and which is now displayed in the recording activation region 14a is in fact of a scene inside a house—it clearly does not meet the requirements of the task instructions. Nevertheless, the system assumes that the task has been correctly completed until validation by a referee indicates otherwise. In most games, all of an alleged winner's recordings of purported task completion must be validated by the referee before the winner is actually confirmed and announced.

Depending on the rules of the game, the player may be able to attempt task one again, by touching recording activation region 14a a second time. However, in some games the rules may prohibit more than a certain number of “retakes”. If a player has reached his limit and has submitted a recording of an unsuccessful attempt to complete the task, then he will never be able to complete all of the tasks within the game. Depending on the game rules and the win criteria, this may or may not make it completely impossible for the player to win the game. It is envisaged that most games will require completion of all tasks to win, but in other games completion of a subset may be enough, especially where there the rules prohibit multiple attempts at the same task.

In some games, a negative validation by the referee (i.e. where the referee declares that a particular recording does not evidence successful completion of the task according to the rules) may result in the player being given another opportunity to attempt the task. In some embodiments the facility may be provided for the referee to use his discretion to allow another attempt or not. For example he may distinguish between a video where the player has tried to do five kick-ups but has actually only managed four, and a short video of nothing whatsoever which appears to have been caused by accidental activation of the recording module.

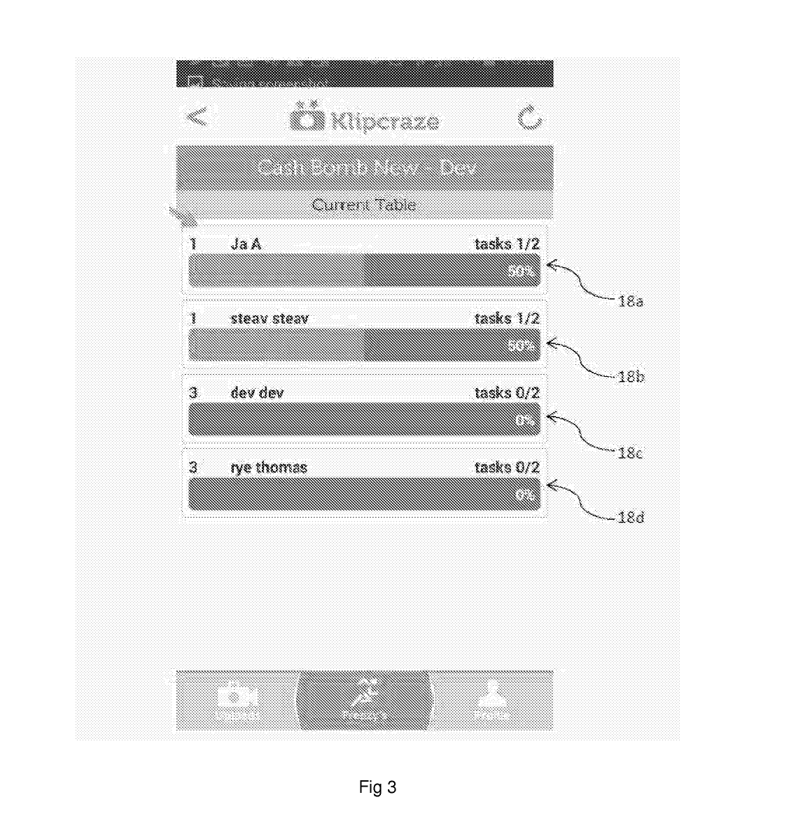

In FIG. 3, the portable device is in a leaderboard display mode, and shows a progress indicator 18a, 18b, 18c, 18d for each player in the game. The leaderboard is updated in real time as players transmit their recordings to the referee. As explained above, transmitted recordings may be assumed to evidence successful task completion for the purposes of the leaderboard display, with the possibility that a player's score may be adjusted downwards if the referee determines that a transmitted recording does not evidence successful completion of the relevant task.

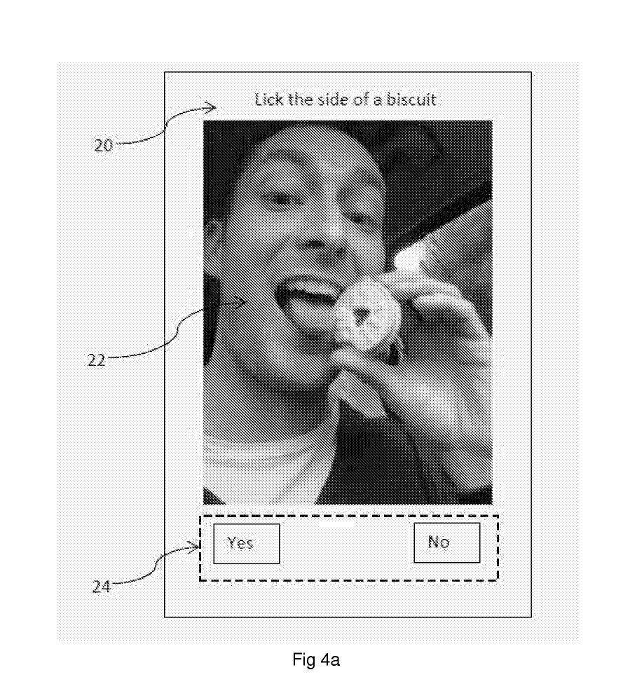

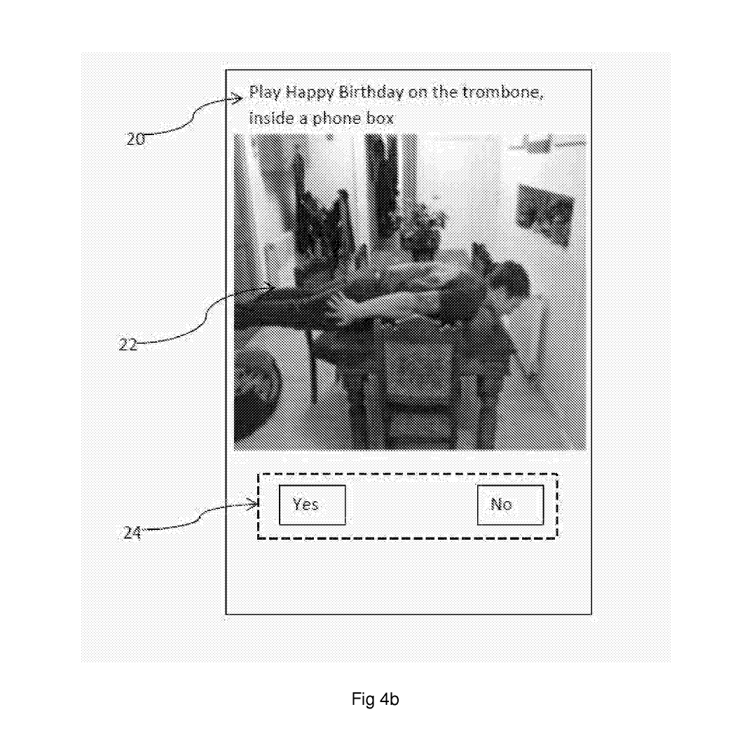

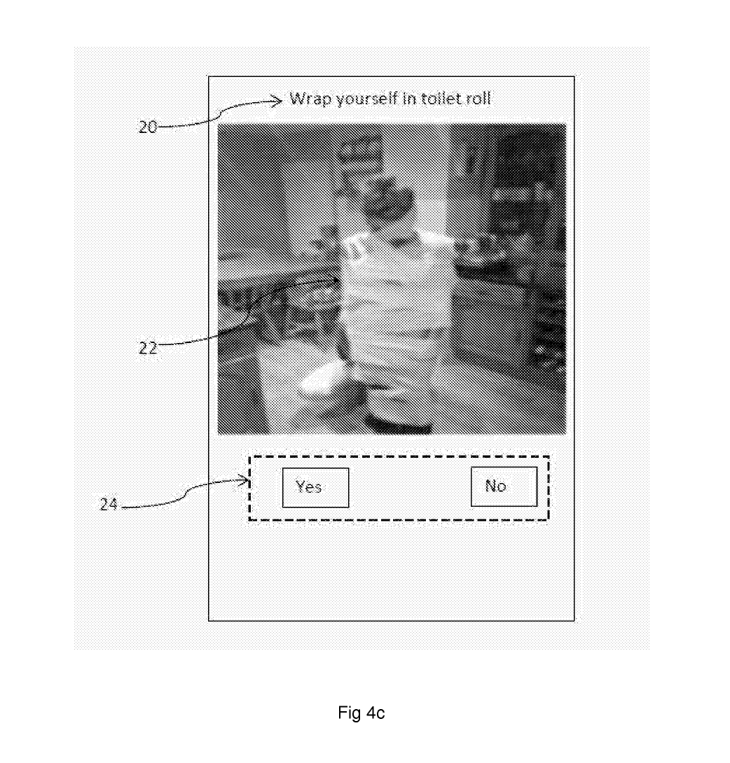

FIGS. 4a, 4b and 4c show example screen displays from a referee device, which is this embodiment is a general purpose computer provided with suitable software. In each screen display, the referee device is in a manual validation mode, which allows a human referee to determine and record whether or not recordings evidence successful completion of tasks. In manual validation mode, the screen display includes a task instruction region 20, a recording playback region 22 and a decision region 24. The task instruction region 20 displays the instructions which were provided to the player for completing the task to which the recording purportedly relates, the recording playback region 22 displays the recording (in this embodiment a photograph of video), and the decision region 24 provides input means for the referee to record whether or not the recording matches the instructions.

In FIG. 4a, the instructions are “Lick the side of a biscuit” and as can be seen in the Figure the photograph in the playback region 22 does indeed show a person licking the side of a biscuit. The referee will therefore click the “Yes” button in the decision region 24.

In FIG. 4b, the instructions for the task are to play the trombone inside a telephone box, but the player has submitted a picture of himself on a table. The referee will therefore click “No” in this case. In FIG. 4c, the task was for the player to wrap himself in toilet roll, and the transmitted photograph appears to evidence successful completion, so the referee will click “Yes”.

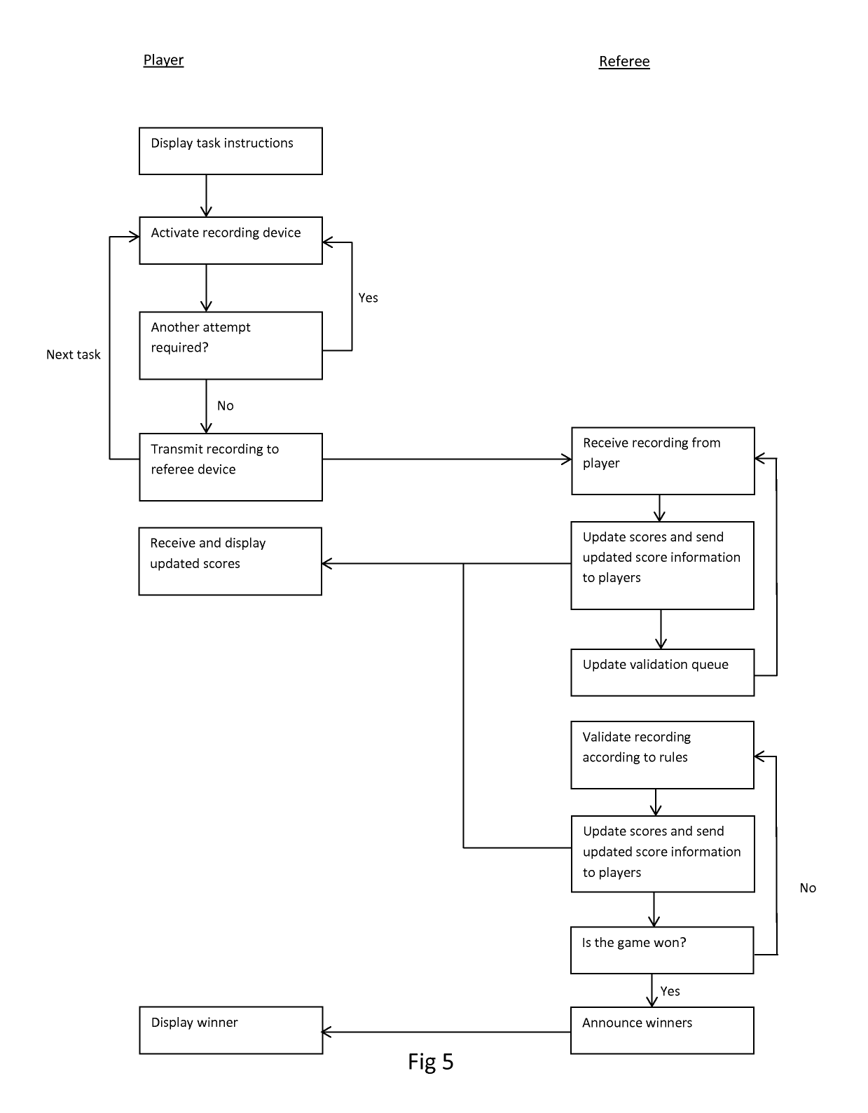

Referring now to FIG. 5, a broad overview of the progress of a game played using the inventive apparatus will now be described. In FIG. 5, steps performed by the player are shown on the left-hand-side, and steps performed by the referee are shown on the right-hand-side.

When the game begins, the player device reveals instructions according to the rules of the game. In this game, instructions for all of the tasks are revealed at the start of the game. The player indicates when he is ready to attempt a task, and the recording device is activated. In this game, a player is allowed multiple attempts to record successful completion of the task. As an example, if the task is to perform five kick-ups, then the player can keep activating the recording device to produce multiple videos of attempts, until he manages to complete all five kick-ups.

When the player is happy with his recording, the recording is transmitted by the player's portable device to the referee, and the player moves on to the next task, activating the recording device to record an attempt. This cycle continues until the either the player has completed all tasks, or the game has been won. If the game is won, the winner is announced by the referee. The player device is configured to receive a win announcement message and to interrupt the cycle of play and end the game.

The player device also continually receives updated scoring/leaderboard information from the referee and displays that information as described above.

When the referee device receives a transmitted recording, the scoreboard is updated (making the assumption that it does indicate valid completion of the task) and the recording is then queued for validation. As described above, recordings may be selected for validation to maximise the efficiency of the referee, and therefore recordings transmitted by players who have been identified as likely winners may “jump the queue”. Asynchronously of the receive/update scores/queue for validation cycle, the referee device validates recordings, which in most embodiments will involve the input of a human referee as described above with reference to FIGS. 4a, 4b and 4c.

After a recording is validated, scores are updated (if a recording was found invalid then the relevant player's score will be reduced). If the win criteria are met then the game is ended and winner(s) announced. Otherwise, the validation process continues.

The embodiments described above are provided by way of example only, and various changes and modifications will be apparent to persons skilled in the art without departing from the scope of the present invention as defined by the appended claims.

1. Apparatus for playing a game involving two or more players and a referee,
the apparatus being suitable for use in games having rules for game play that include instructions for performing tasks, rules as to when the instructions for performing the tasks are revealed to players, as to the order and timing which players must apply to performance of the tasks, and as to the allocation and selection of tasks to and by players, and the rules further including win criteria for determining one or more winner(s) of the game dependent on the performance of tasks by the players,
the apparatus comprising a portable device for use by each player, the portable device including a recording module, a display module and a transmitting module, the portable device being adapted to perform the steps of:
a) revealing instructions for performing at least one task on the display module, according to the rules;
b) activating the recording module to allow the player to make a recording of an attempt to perform at least one of the revealed task(s);
c) returning to step (b) for a next task according to the rules, until the referee indicates that the game has ended,
and in which the portable device is further adapted to transmit each recording to the referee.

2. Apparatus as claimed in claim 1, in which the recording module includes a camera, and each recording is a photograph or video recording.

3. Apparatus as claimed in claim 1, in which the portable device is further adapted to perform the step of:
b(i)) revealing instructions for performing at least one next task, according to the rules,
step b(i) taking place after step (b) and before step (c)

4. Apparatus as claimed in claim 1, in which the instructions for performing more than one of the tasks as defined in the rules to be allocated to the player who is using the portable device are revealed at step (a).

5. Apparatus as claimed in claim 4, in which step (b) allows the player to choose which of the revealed tasks they are to attempt and record.

6. Apparatus as claimed in claim 1, in which each recording is transmitted to the referee after step (b) and before step (c).

7. Apparatus as claimed in claim 1, in which recordings are transmitted to the referee asynchronously of the steps.

8. Apparatus as claimed in claim 1, in which the portable device is further adapted to perform the step of:
b(ii)) accepting input from the player to accept or reject the recording made, and if the user accepts the recording then proceeding to step (c), and if the user rejects the recording then returning to step (b) to make a new recording of an attempt at the same task,
step b(ii) taking place after step (b) and before step (c).

9. Apparatus for playing a game as claimed in claim 1, further comprising a referee device, the referee device including:
a receiving module for receiving recordings transmitted by players' portable devices;
a validation module for determining whether or not selected recordings evidence the correct completion of a task according to the rules;
a scoring module for tracking which recordings have been validated, tracking the performance of each player and determining when the win criteria according to the rules has been met;
a transmitting module for transmitting a notification to players when the game has been won.

10. Apparatus as claimed in claim 9, in which the validation module of the referee device includes a playback module for playing or displaying selected recordings and an input module,
the referee device being adapted to perform the steps of:
(a) selecting a recording for validation according to rules;
(b) playing or displaying the selected recording on the playback module;
(c) accepting input as to whether or not the selected recording indicates correct completion of a task according to the rules;
(d) updating stored data in the scoring module to include the information input at step (c).

11. A method of playing a game involving two or more players and a referee,
the method being suitable for use in games having rules for game play that include instructions for performing tasks, rules as to when the instructions for performing the tasks are revealed to players, as to the order and timing which players must apply to performance of the tasks, and as to the allocation and selection of tasks to and by players, and the rules further including win criteria for determining one or more winner(s) of the game dependent on the performance of tasks by the players,
the method comprising the steps of:
(a) providing each player with a portable device which includes a recording module, a transmitting module and a display module, the portable device being adapted to reveal instructions for performing tasks according to the rules, allow recordings to be made of attempts to complete said tasks, and transmit the recordings to the referee;
(b) each player completing a plurality of tasks according to the rules, the step of completing a task comprising:
i. viewing revealed instructions for performing a task on the display module of his portable device;
ii. attempting to perform the task and recording the attempt on the recording module of his portable device.

12. A method of playing a game as claimed in claim 11, in which each player executes the step of completing a task asynchronously and independently of the other players.

13. A method of playing a game as claimed in claim 11, further comprising the steps of
the referee receiving recordings of attempts to complete tasks from the portable devices provided to players;
the referee validating a plurality of recordings, the step of validating a recording comprising:
(a) playing back the recording and determining whether or not the task has been successfully completed according to the rules;
(b) marking the recording as to whether or not it evidences successful completion of the task.

14. A method as claimed in claim 13, in which the referee performs the step of validating a recording asynchronously of receiving recordings from players.

15. A method as claimed in claim 11, in which the recording is a photograph or video.

16. A method of playing a game involving two or more teams and a referee, each team including two or more players,
the method being suitable for use in games having rules for game play that include instructions for performing tasks, rules as to when the instructions for performing the tasks are revealed to players, as to the order and timing which players must apply to performance of the tasks, and as to the allocation and selection of tasks to and by players, and the rules further including win criteria for determining one or more winning team(s) dependent on the performance of tasks by the players,
the method comprising the steps of:
(a) providing each player with a portable device which includes a recording module, a transmitting module and a display module, the portable device being adapted to reveal instructions for performing tasks according to the rules, allow recordings to be made of attempts to complete said tasks, and transmit the recordings to the referee;
(b) each team completing a plurality of tasks according to the rules, the step of completing a task comprising:
i. at least one player in the team viewing revealed instructions for performing a task on the display module of his portable device;
ii. at least one player in the team attempting to perform the task; and
iii. at least one player in the team recording the attempt on the recording module of his portable device.

17. A method of playing a game as claimed in claim 16, in which a single step of completing a task is performed in its entirety by a single player in the team.

18. A method of playing a game as claimed in claim 16, in which the step of completing a task involves two or more players in the team attempting to perform the task, while at least one player in the team makes a single recording of the attempt.

19. A method of playing a game as claimed in claim 16, in which each team completes the same plurality of tasks.

20. A method of playing a game as claimed in claim 19, in which at least one player in a first team completes a different set of tasks from any player in a second team.
